(19) United States
(12) Patent Application Publication
(10) Pub. No.: US 2010/0127621 A1
(43) Pub. Date: May 27, 2010

(54) METHOD FOR MANFACTURING FLAT PANEL DISPLAY AND PANEL FOR FLAT PANEL DISPLAY

(76) Inventor: Masahiro Watabe, Miyazaki (JP)

Correspondence Address: MILES & STOCKBRIDGE PC, 1751 PINNACLE DRIVE, SUITE 500, MCLEAN, VA, 22102-3833, US

(21) Appl. No.: 12/089,365

(22) PCT Filed: Dec. 16, 2005
(86) PCT No.: PCT/JP2005/023164

§ 371 Date: Apr. 4, 2008

(51) Int. Cl. H01J 17/49; B05D 5/12

(52) U.S. Cl. 313/582; 427/69

(57) ABSTRACT

A method for forming a film includes a step of forming an insulator layer (17) on a substrate (111) on which electrodes (X and Y) are arranged, by a chemical vapor deposition process. Masks (71 and 72) having a shape covering terminal parts (Xt and Yt) of the electrodes (X and Y) are disposed proximately to the terminal parts (Xt and Yt) so as to be separated from the terminal parts (Xt, Yt) and to be opposed to the same. The insulator is deposited on the electrodes (X and Y) at a deposition rate of chemical vapor deposition that is lower at the terminal parts (Xt and Yt) than at parts of the electrodes (X and Y) that are not covered with the masks (71 and 72).

### TECHNICAL FIELD

The present invention relates to a process for manufacturing a flat panel display in which coating of electrodes is performed by a chemical vapor deposition process.

### BACKGROUND ART

The chemical vapor deposition (CVD) process is a method for forming a film from a source gas by a chemical reaction, which is widely used for industrial applications including formation of a thin film of a micro device such as a semiconductor device and coating of an object in the order of meters.

The CVD process has recently been used also for manufacturing a flat panel display having a large screen of one meter diagonal size or larger. Japanese Patent No. 3481142 describes a method for manufacturing an AC plasma display panel in which a dielectric layer for coating electrodes is formed by a plasma enhanced CVD process. According to the CVD process, it is possible to obtain a dielectric layer having a thin and uniform thickness. In addition, compared to a thick film process, it is possible to form the dielectric layer made of a material such as silicon dioxide or organic silicon oxide having a smaller relative dielectric constant than a low melting point glass as a common material at low temperatures.

If the object has a part not to be coated in the CVD process for forming a film, masking of the part is performed. Japanese unexamined patent publication No. 2003-324075, which is a related-art document about masking, discloses a masking member that is a combination of a rectangular frame and a thin band-like member.

[Patent Document 1] Japanese Patent No. 3481142

[Patent Document 2] Japanese unexamined patent publication No. 2003-324075

### DISCLOSURE OF THE INVENTION

If the dielectric layer that covers electrodes is formed by the CVD process in the manufacturing process of a plasma display panel, it is difficult to make terminal parts of the electrodes be exposed without loss of mass production efficiency.

In order to make terminal parts of the electrodes be exposed, the dielectric layer should be removed partially after depositing the dielectric so as to cover the entire of the electrodes or masking is performed by placing a mask on the terminal parts of the electrodes before depositing the dielectric on the substrate on which the electrodes are arranged.

A common method for removing the dielectric layer partially is a wet etching process. However, when the wet etching process is used, the terminal parts of the electrodes are apt to disappear. In other words, there is no appropriate etchant that has selectivity for dissolving the dielectric layer formed by the CVD process and not dissolving the electrodes and that has excellent cost efficiency and safety. For example, hydrofluoric acid that can dissolve silicon dioxide does not have selectivity for copper or chromium that is a typical material of the terminal parts of electrodes. Therefore, if the dielectric layer made of silicon dioxide is etched by the hydrofluoric acid, it is necessary to perform very precise etching control for minimizing dissolution of the terminal parts of electrodes and to decrease an etching rate for this purpose. As a result, the turnaround time becomes long.

On the other hand, the masking method is useful from the viewpoint of the turnaround time because it does not need to make the terminal parts be exposed after forming the film. However, it has a problem that occurrence probability of a break or a continuity defect of an electrode may be increased due to the masking.

An object of the present invention is to enhance mass production efficiency in manufacturing a flat panel display having an insulator layer that covers electrodes and is formed by the chemical vapor deposition process.

A method for forming a film for achieving the object of the present invention is a method for manufacturing a flat panel display in which an insulator layer is formed by a CVD process on a substrate on which electrodes are arranged, and includes the steps of disposing a mask having a shape covering terminal parts of the electrodes so as to be close to, but be separated from and be opposed to the terminal parts, and depositing an insulator on the electrodes at a deposition rate of chemical vapor deposition that is lower at the terminal parts than at parts of the electrodes that are not covered with the mask.

The inventor found that a break of an electrode is caused when the mask touches the electrode. It was found that if the mask touches the electrode, the terminal part can be damaged largely or the surface of the terminal part can be damaged resulting in oxidation of the surface in a heat treatment process after the film forming process. Therefore, according to the present invention, the mask is disposed away from the terminal part by a tiny distance so as to be opposed to the same. Since there is a gap between the mask and the terminal parts, the insulator will be deposited also on the terminal parts in the CVD process unlike the case where the mask contacts the electrode. However, the deposition rate depends on a size of the gap. Since the deposition rate is lower as the size of the gap is smaller, the thickness of the insulator layer formed on the terminal parts of the electrode is sufficiently thinner than that formed on other parts in the film forming process in the state where the mask is close to the terminal parts.

If the thin insulator layer covering the terminal parts can be an obstacle to electric connection to the terminal parts, it is removed by a chemical or physical etching process, a sanding process or other methods prior to the electric connection. The thin insulator layer can be removed in a shorter time than the case of removing a thick insulator layer. In order to reduce the time necessary for removing the thin insulator layer, it is desirable that the thickness of the insulator layer covering the electrodes at the terminal parts be 1/10 or less of the thickness of the same at other parts.

If the insulator layer covering the terminal parts is very thin, i.e., if a wiring conductor can break the insulator layer and is connected electrically to the terminal part when it is pressed to contact the terminal part, it is not necessary to remove the insulator layer prior to the electric connection.

### BRIEF DESCRIPTION OF THE DRAWINGS

FIG. 1 is an exploded perspective view showing an example of a cell structure of a plasma display panel.

FIG. 2 is a plan view showing a layout pattern of display electrodes.

FIG. 3 is a plan view showing regions to be masked when a dielectric layer is formed in a manufacturing process of the plasma display panel.

FIG. 4 is a plan view of a mask.

FIG. 5 is a plan view of a mask and a frame for supporting the same.

FIG. 6 is a schematic diagram showing a general structure of a plasma CVD device.

FIGS. 7(A) and 7(B) are cross sectional views showing the masking according to the present invention.

FIG. 8 is a cross sectional view showing a first example of a panel structure according to the present invention.

FIG. 9 is a cross sectional view showing a second example of the panel structure according to the present invention.

### BEST MODE FOR CARRYING OUT THE INVENTION

Hereinafter, a method of the present invention for manufacturing a plasma display panel as an example will be described.

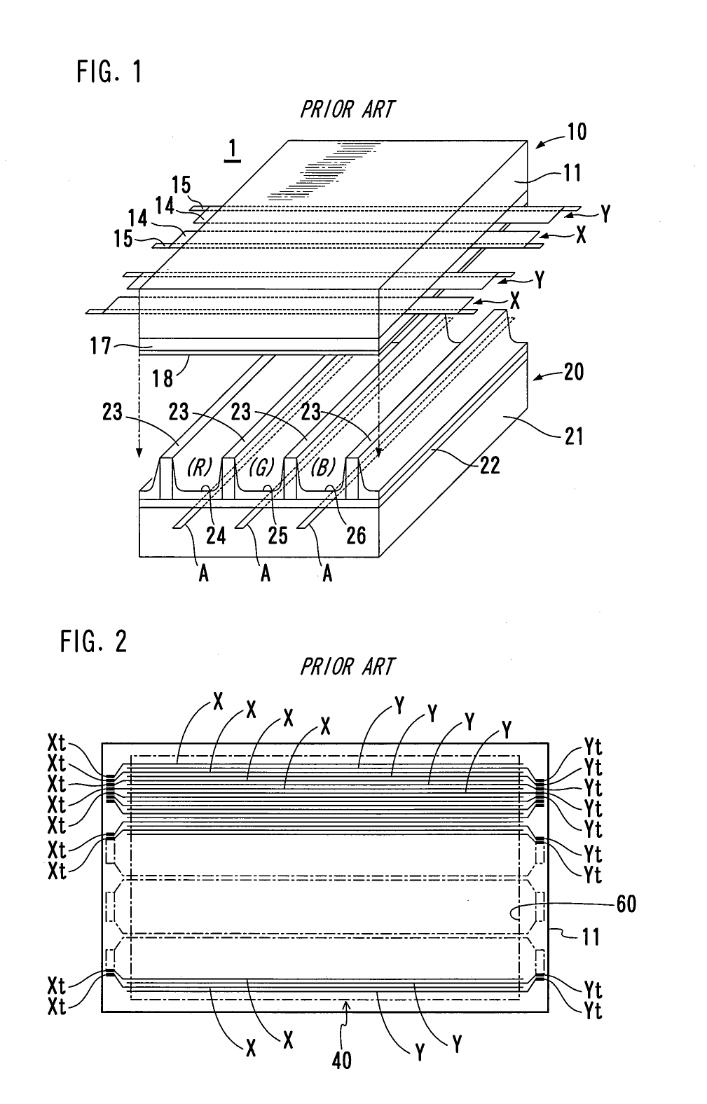

A typical plasma display panel has a cell structure as shown in FIG. 1. FIG. 1 shows a part including six cells corresponding to three columns in two rows, in which a front plate 10 and a rear plate 20 are separated for easy understanding of the internal structure.

The plasma display panel 1 includes the front plate 10, the rear plate 20 and discharge gas (not shown). The front plate 10 includes a glass substrate 11, first row electrodes X, second row electrodes Y, a dielectric layer 17, and a protection film 18. Each of the row electrodes X and the row electrodes Y is a laminate of a patterned transparent conductive film 14 and a metal film 15. The rear plate 20 includes a glass substrate 21, column electrodes A, a dielectric layer 22, a plurality of partitions 23, a red (R) fluorescent material 24, a green (G) fluorescent material 25, and a blue (B) fluorescent material 26.

As display electrodes for generating surface discharge, the row electrodes X and the row electrodes Y are arranged alternately on the inner surface of the glass substrate 11 and are covered with the dielectric layer 17 and the protection film 18. The dielectric layer 17 is an essential element for the AC plasma display panel. The coating with the dielectric layer 17 enables surface discharge to be generated repeatedly by utilizing wall charge accumulated in the dielectric layer 17. The protection film 18 protects the dielectric layer 17 from sputtering.

Note that either one of the well-known arrangement forms of the row electrodes can be adopted in the embodiment of the present invention. One of them is as shown in FIG. 1, in which an electrode gap between neighboring rows is larger than an electrode gap in each row (i.e., a surface discharge gap). The other arrangement has a uniform row electrode gap for all rows.

FIG. 2 is a plan view showing a layout pattern of the display electrodes. The row electrodes X and the row electrodes Y that constitute a display electrode group 40 extend from the screen 60 to the vicinity of the edge of the glass substrate 11, and terminals Xt and Yt are disposed at the end of them for electric connection with a drive unit. In FIG. 2, the terminals Xt of the row electrodes X are disposed on the left end side of the glass substrate 11, while the terminals Yt of the row electrodes Y are disposed on the right end side of the glass substrate 11. An arrangement pitch of the terminals Xt is different from an arrangement pitch of the row electrodes X on the screen 60, so the left end parts of the row electrodes X (including the terminals Xt) are patterned in shapes like curved bands. This curved part is not the laminate of the transparent conductive film 14 and the metal film 15 but is made of only the metal film 15. In the same manner, the right end parts of the row electrodes Y (including the terminals Yt) are patterned in shapes like curved bands, and this curved part is made of only the metal film 15.

The plasma display panel 1 having the structure described above is manufactured according to the procedure in which the front plate 10 and the rear plate 20 are made separately and after that they are glued to each other. In general, a mother glass plate having an area twice or more of the glass substrate 11 is used for manufacturing the front plate 10, so that a plurality of front plates 10 are made at one time. In the same manner, a plurality of rear plates 20 are made at one time. Prior to gluing the front plate 10 and the rear plate 20 together, the mother glass plate is divided so that each of the front plates 10 is glued to each of the rear plates 20 to be one unit.

In the manufacturing process of the front plate 10, the dielectric layer 17 made of a single layer is formed by the CVD process, in which the masking of the terminals Xt and Yt is performed. If the masking is not performed, the entire of the display electrode group 40 including the terminals Xt and Yt will be covered with the dielectric layer 17 of a single layer having a uniform thickness. Then, it will take a long time to make the terminals Xt and Yt be exposed by an etching process or a sanding process. Since the masking is performed, a step for removing the dielectric layer 17 partially becomes unnecessary, or it can be removed in a relatively short time even if the step is necessary.

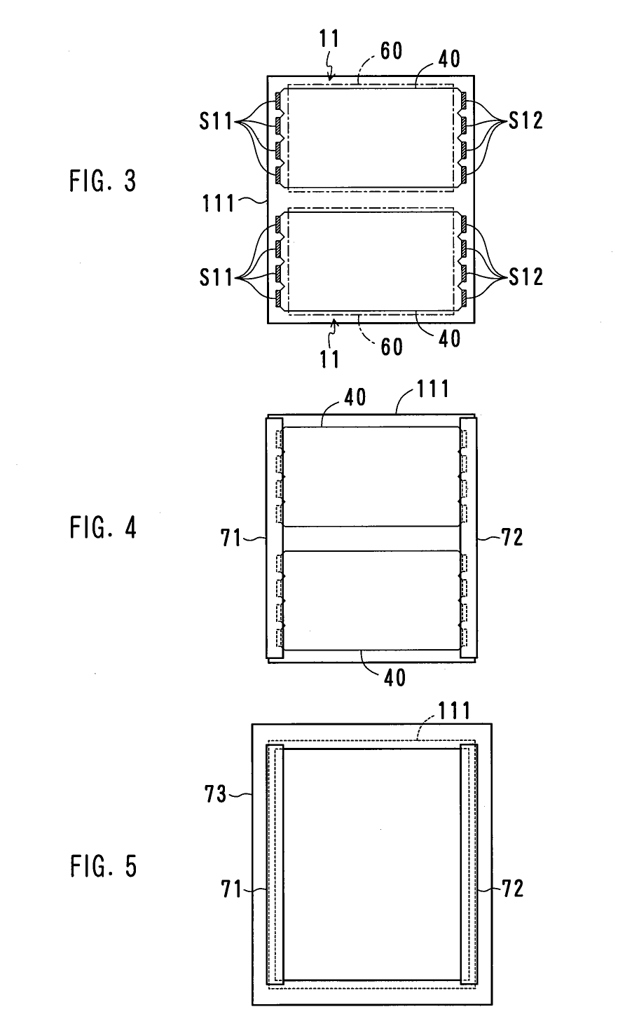

If two glass substrates are obtained from one mother glass plate (two in one) as an example, in the formation of the dielectric layer, the masking should be performed on the regions S11 and the regions S12 as shown in FIG. 3. In FIG. 3, two display electrode groups 40 are formed in parallel on a mother glass plate 111. The part of the mother glass plate 111 where the display electrode group 40 is arranged and the vicinity of the part correspond to the glass substrate 11 on the front side of one plasma display panel. The region S11 corresponds to the terminal parts on the left side of each of the display electrode groups 40 while the region S12 corresponds to the terminal parts on the right side of each of the display electrode groups 40 in FIG. 3.

The masking is performed by using two masks 71 and 72 as shown in FIG. 4. The masks 71 and 72 are elongated band-like plates made of an insulation material such as a ceramic or a heat-resistant glass and are disposed so as to overlap the mother glass plate 111 at the end parts.

A size of the masks 71 and 72 is selected in accordance with a size of a screen of the plasma display panel. For example, the glass substrate of the plasma display panel having a 42 inch diagonal screen 60 has dimensions of approximately 994 mm×585 mm. If the glass substrate is obtained in “two in one”, the area of the mother glass plate 111 should be larger than two times the screen (994 mm×1170 mm). A width of the masks 71 and 72 is approximately 20-30 mm, and a length of the same is approximately the same as the corresponding side of the mother glass plate 111. A thickness of the same is approximately 5±2 mm.

When the masks 71 and 72 are used, they are supported by a rectangular frame 73 as shown in FIG. 5. The frame 73 is a rigid body made of an aluminum alloy having a thickness of approximately 30 mm, and it is larger and thicker than the mother glass plate 111. Thus, the frame 73 is provided with a sufficient mechanical strength as a pressure member for preventing the mother glass plate 111 from being warped by heat.

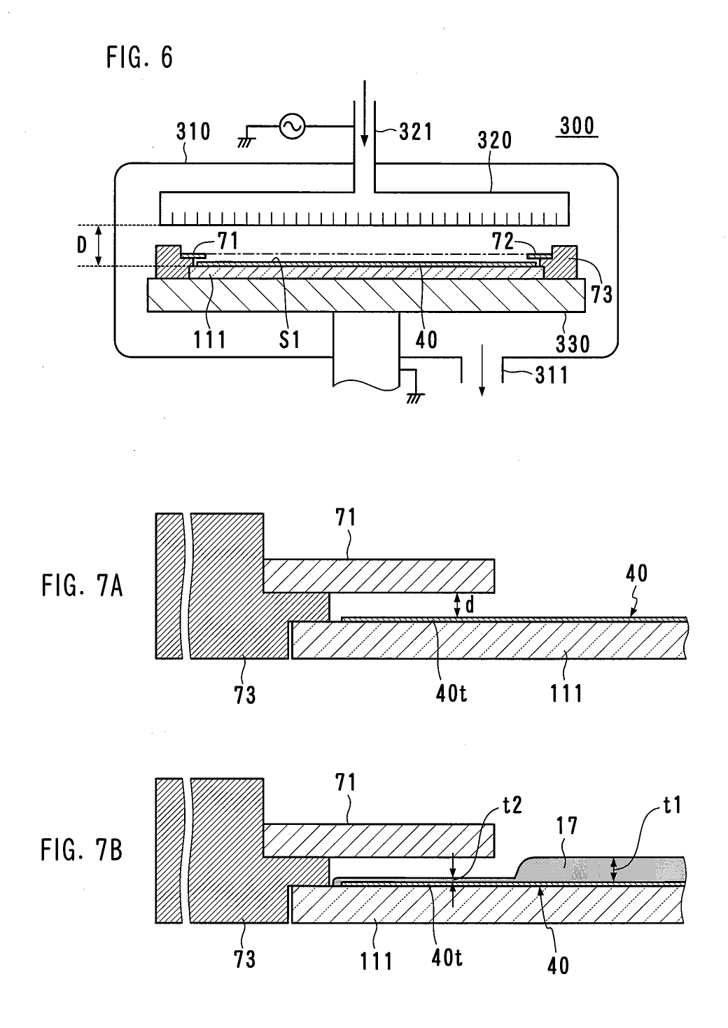

The dielectric layer is formed by using the masks 71 and 72 in a plasma CVD device 300 shown in FIG. 6, which is a parallel plate type. The plasma CVD device 300 includes a chamber (a reaction chamber) 310 made of a metal container, a shower plate 320 for spouting source gas uniformly in a wide range, a movable base 330 for supporting an object on which a film should be formed, the masks 71 and 72 for the above-mentioned masking, and the frame 73 for supporting the masks 71 and 72.

The shower plate 320 also works as an upper electrode for generating plasma, and the movable base 330 also works as a lower electrode. A heater for heating the object on which the film should be formed is embedded in the movable base 330.

Inside the chamber 310, the masks 71 and 72 are disposed between the shower plate 320 and the movable base 330. In the illustrated state of forming the film, the mother glass plate 111 on which the display electrode groups 40 are formed is placed on the movable base 330, so that the lower faces of the masks 71 and 72 are disposed close to the upper faces of the display electrode groups 40. Plasma is generated in the space between the display electrode groups 40 and the shower plate 320. A distance D between the mother glass plate 111 and the shower plate 320 is selected to be approximately 10 to 20 mm.

The movable base 330 in this example is a lift type that can move up and down. When the mother glass plate 111 is carried in or out, the movable base 330 moves down so as to be separate from the fixed frame 73. The chamber 310 is provided with a mechanism for carrying the mother glass plate 111 in and out, which has an interlock function.

A general outline of the film forming step is as follows.

Air pressure inside the chamber 310 in which the mother glass plate 111 is carried in is reduced to approximately 2.5 to 3.5 Torr, for example, and the mother glass plate 111 is heated to a temperature of approximately 200 to 400 degrees centigrade. In this state, the source gas is led into the chamber 310 through an inlet hole 321 that is formed in the center of the shower plate 320. If the dielectric layer made of silicon dioxide is formed, silane gas (SiH₄) and nitrous oxide (N₂O) are led in as the source gas, for example. The source gas spouts from the shower plate 310 toward the entire of the mother glass plate 111 substantially uniformly.

Concomitantly with leading the source gas, air in the chamber 310 is exhausted through a main outlet hole 311 that is located below the movable base 330. The chamber 310 is provided with a vacuum meter (not shown), and a valve of an exhaust system is controlled in accordance with an output signal of the vacuum meter so that a degree of vacuum inside the chamber 310 can be maintained at a constant value.

Thus, the inside of the chamber 310 is supplied with a constant quantity of source gas, and the plasma generated by a high frequency electric power of 1.5 to 2.5 kW activates the source gas so as to promote the chemical reaction. Then, film material generated by the chemical reaction is deposited on the film forming surface S1 of the mother glass plate 111 so that the dielectric layer is formed. The film forming surface S1 in this example is the upper face of the mother glass plate 111 on which the display electrode group 40 is formed. Strictly speaking, it includes the exposed surface of the display electrode group 40 and the surface of the substrate between the electrodes.

In this film forming process, the masks 71 and 72 are disposed proximately to terminal parts 40t of the display electrode group 40 so as to be separated from the terminal parts 40t and to be opposed to the same as shown in FIGS. 7(A) and 7(B). Although only the mask 71 is shown in FIGS. 7(A) and 7(B), the mask 72 is also disposed proximately to terminal parts (not shown) of the display electrode group 40 in the same manner as the mask 71. However, the terminal parts 40t to which the mask 71 is opposed corresponds to the region S11 shown in FIG. 3 while the terminal parts to which the mask 72 is opposed corresponds to the region S12.

When the film forming process is started, as shown in FIG. 7(A), a set value of a distance d between the mask 71 and the terminal parts 40t of the display electrode group 40 is approximately 0.5 to 2.0 mm. The value of the distance d is sufficiently small compared with the distance D between the mother glass plate 111 and the shower plate 320. Therefore, a deposition rate of the chemical vapor deposition on the terminal parts 40t is extremely smaller than a deposition rate thereof on the parts of the display electrode group 40 that is not covered by the mask 71. For example, the former rate is one tenth or lower of the latter rate. Therefore, as to the dielectric layer 17 thus formed as shown in FIG. 7(B), a thickness t2 of the part covering the terminal parts 40t is extremely smaller than a thickness t1 of the other parts. Note that the thickness of the dielectric layer 17 is exaggerated in FIGS. 7(A) and 7(B). The actual thickness t1 of the dielectric layer 17 is approximately 5 to 20 microns, which is much smaller than the distance d. The thickness t2 is a further small value.

Since the masks 71 and 72 for the masking process do not touch the display electrode groups 40 in the film forming process, the display electrode groups 40 are not damaged. Since the terminal parts 40t are coated by the thin dielectric layer, the display electrode group 40 is not oxidized even if the mother glass plate 111 is exposed to the air or a heat treatment carried out in the air after the film forming process.

After forming the dielectric layer 17 having a single layer that is partially thin in this way, magnesia is deposited as the protection film 18, for example. On this occasion, it is possible to mask a region where the deposition is unnecessary, in addition to the display region. After the protection film 18 is formed, the mother glass plate 111 is divided into a plurality of front plates 10. The front plate 10 and the rear plate 20 that is manufactured separately are put together and are combined to be a one unit. After they are combined, the thin dielectric layer covering the terminal parts 40t of the display electrode group 40 on the front plate 10 is removed by the etching process or the sanding process if necessary. If the insulator covering the terminal parts 40t is sufficiently thin, e.g., if its thickness is a few thousand angstroms or smaller, external conductors of a flexible printed circuit board or the like can break the thin insulator so as to make electric contacts with the terminal parts 40t by pressing the external conductors onto the terminal parts 40t. In this case, the process for removing the thin dielectric layer covering the terminal parts 40t can be omitted.

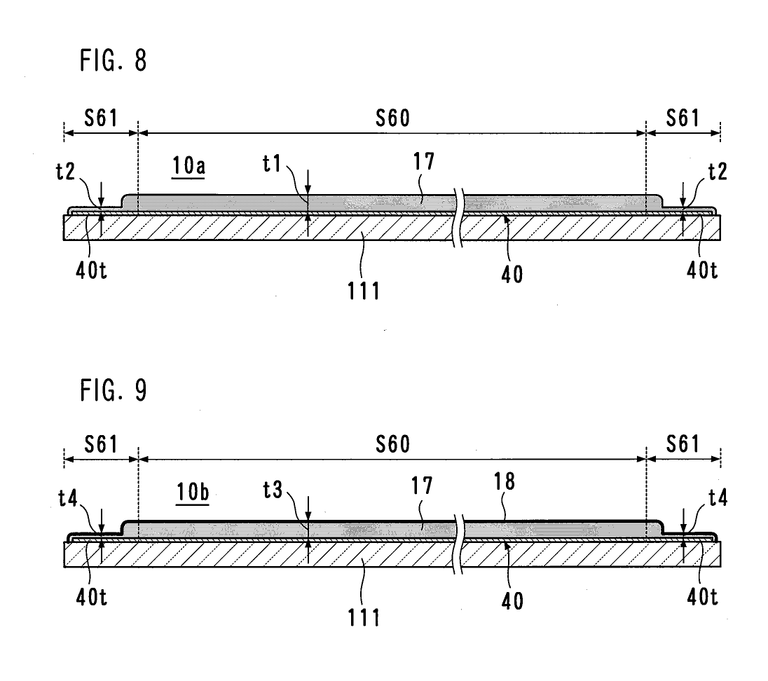

FIG. 8 is a cross sectional view showing a first example of a panel structure according to the present invention. A panel 10a shown in FIG. 8 is the mother glass plate 111 at the stage when the film formation of the dielectric layer 17 made of a single layer is finished in the manufacturing process of the plasma display panel 1, and it is a work piece of the front plate 10.

In the panel 10a, the display electrode group 40 extends from the display region S60 corresponding to the screen of the mother glass plate 111 to its periphery that is a non-display region S61, so it includes the terminal parts 40t located in the non-display region S61. In addition, the dielectric layer 17 covers the part of the display electrode group 40 in the display region S60 and the terminal parts 40t. The thickness t2 of the part of the dielectric layer 17 covering the terminal parts 40t is one tenth or smaller of the thickness t1 of the part thereof covering the part located in the display region S60.

FIG. 9 is a cross sectional view showing a second example of the panel structure according to the present invention. A panel 10b shown in FIG. 9 is the mother glass plate 111 at the stage when the film formation of the protection film 18 on the dielectric layer 17 is finished in the manufacturing process of the plasma display panel 1, and it is a work piece of the front plate 10.

In the illustrated panel 10b, the protection film 18 is formed so as to cover the entire of the dielectric layer 17 made of a single layer at a uniform thickness. As to a thickness of the insulator (a laminate of the dielectric layer 17 and the protection film 18) that covers the display electrode group 40, a thickness t4 of the part that covers the terminal parts 40t is one tenth or smaller of a thickness t3 of the part within the display region S60.

When the panel 10a or the panel 10b is used for manufacturing the plasma display panel 1, the terminal parts 40t are not damaged when the dielectric layer 17 is formed as described above, so that a break or a continuity defect of an electrode hardly occurs. Since the terminal parts 40t are not covered by a thick insulator like that in the display region S60, the terminal parts 40t can be exposed fast or exposed by pressing the external conductors for electric connection. In other words, the yields can be improved while the production time can be reduced.

In the embodiment of the present invention, the mask pattern should be selected in accordance with a shape of an object on which the film should be formed, so it is not limited to the pattern shown in FIG. 4. Without limiting to “two in one”, the present invention can be applied to “one in one” in which a single glass substrate is obtained from the mother glass plate, or “n in one” in which n (three or more) glass substrates are obtained from the mother glass plate.

The panel according to the present invention includes the illustrated panel 10a or 10b, and the front plate (or the rear plate) corresponding to each plasma display panel obtained by dividing the panel 10a or 10b.

The materials of the masks 71 and 72 and the frame 73, the sizes thereof in a plan view, the thickness thereof, the value of the gap d between the mask 71 or 72 and the electrodes, the number of the masks 71 and 72 as well as the arrangement thereof, the structure of the film forming device and the like can be selected appropriately within a scope of the present invention in accordance with the spirit thereof.

### INDUSTRIAL APPLICABILITY

The present invention is useful for forming an electrode coating film by a chemical vapor deposition process, and it can be used for manufacturing a flat panel display including a plasma display panel or a liquid crystal panel.

1. A method for manufacturing a flat panel display in which an insulator layer is formed by a chemical vapor deposition process on a substrate on which electrodes are arranged, the method comprising the steps of:
disposing a mask having a shape covering terminal parts of the electrodes so as to be close to, but be separated from and be opposed to the terminal parts; and
depositing an insulator on the electrodes at a deposition rate of chemical vapor deposition that is lower at the terminal parts than at parts of the electrodes that are not covered with the mask.

2. The method for manufacturing a flat panel display according to claim 1,
wherein the deposition rate at the terminal parts is one tenth or lower of the deposition rate at the parts of the electrodes that are not covered with the mask.

3. A panel used for manufacturing a flat panel display, comprising:
a substrate having a larger area than a screen;
electrodes arranged on the substrate; and
a dielectric layer made of a single layer for covering the electrodes,
the electrodes extending from a display region corresponding to the screen on the substrate to a non-display region in a periphery of the display region, and including terminal parts located in the non-display region,
the dielectric layer covering parts of the electrodes located in the display region and the terminal parts, and
a thickness of a part of the dielectric layer covering the terminal parts of the electrodes being one tenth or smaller of a thickness of a part of the dielectric layer covering the parts of the electrodes located in the display region.

4. The panel used for manufacturing a flat panel display according to claim 3,
wherein a protection film is formed on the dielectric layer.

5. The panel used for manufacturing a flat panel display according to claim 3,
wherein the substrate is a mother substrate that is used for manufacturing a plurality of flat panel displays, each of the flat panel displays including a plurality of arranged electrodes corresponding to one flat panel display and a dielectric layer covering the plurality of arranged electrodes.

6. The panel used for manufacturing a flat panel display according to claim 4,
wherein the substrate is a mother substrate that is used for manufacturing a plurality of flat panel displays, each of the flat panel displays including a plurality of arranged electrodes corresponding to one flat panel display and a dielectric layer covering the plurality of arranged electrodes.
